(19) United States
(12) Patent Application Publication
(10) Pub. No.: US 2005/0029896 A1
(43) Pub. Date: Feb. 10, 2005

(54) Brush holder assembly

(76) Inventors: Jan Stewart, Pittsburgh, PA (US); David W. Minnotte, Pittsburgh, PA (US); William Madden, Carnegie, PA (US); Timothy Bokol, Fairview, PA (US)

Correspondence Address: Tara L. Pfaeffle;Pietragallo, Bosick & Gordon, One Oxford Centre, 38th Floor, 301 Grant Street, Pittsburgh, PA, 15219, US

(21) Appl. No.: 10/889,373

(22) Filed: Jul. 12, 2004

Related U.S. Application Data
(60) Provisional application No. 60/486,646, filed on Jul. 11, 2003.

(51) Int. Cl. H02K 13/00

(52) U.S. Cl. 310/239

(57) ABSTRACT

The present invention provides a brush holder assembly for holding carbon brushes against the commutator of a DC motor. The brush holder assembly may include elongated brush receptacles that can accommodate longer carbon brushes, and a double fulcrum design that assists in holding the brushes against the commutator with constant force, or a nearly constant force. In a particular embodiment, the brush holder assembly may be mounted within the motor housing of an off-highway vehicle with a motorized wheel, a locomotive, or an oil rig. For these kinds of applications, the space between the motor housing and the commutator may be particularly narrow and confined, and the double fulcrum design makes it possible to employ brushes with greater lengths of useful carbon and to manually replace them with minimal down time.

### CROSS-REFERENCE TO RELATED APPLICATION

This application claims the benefit of U.S. Provisional Patent Application Ser. No. 60/486,646, filed Jul. 11, 2003, the disclosure of which is hereby incorporated by reference.

### FIELD OF THE INVENTION

The present invention relates to a brush holder assembly for a direct current motor, and more particularly relates to a brush holder assembly for off-highway vehicles with motorized wheels, locomotives, and oil rigs.

### BACKGROUND INFORMATION

A direct current (DC) motor operates by converting electrical energy into mechanical energy. Electric current is passed through a wire loop located in a magnetic field, which causes the loop to rotate and provide mechanical energy to a shaft. Stationary parts of the motor are referred to as the stator; moving parts, including the wire loop, are referred to as the rotor or armature. The electric current is fed to the wire loop using carbon brushes that make contact with an extension of the armature known as the commutator. Together, the brush and commutator act as a switch that changes the direction of the electric current for each half-rotation of the wire loop, causing the loop to continually rotate in a single direction.

The carbon brushes are held in place with a brush holder, which secures the brushes in the proper position in relation to the contact surface of the commutator. The brush holder may also provide means for applying contact force on the brushes to hold them against the commutator. Over time, the carbon brushes wear away and must be replaced, requiring periodic shut-down and maintenance of the motor. To mitigate the need for frequent brush replacement, long-lasting carbon brushes that contain the maximum possible length of useful carbon are preferred.

Replacement of carbon brushes can be particularly problematic when the motor housing restricts manual access to the brush holder. For example, in off-highway vehicles with motorized wheels, locomotives, and oil rigs, the brush holder is mounted in a narrow space between the motor housing and armature, making access extremely difficult. Conventional brush holders for these types of motors often include a spring-loaded, linear lever that pivots about a single point. When the lever is closed, it applies pressure against the brush, holding the brush against the commutator. When the lever is open, it clears just enough space around the brush holder to allow for manual replacement of the brush. However, given the linear design of the lever and the tight housing constraints of the motor, conventional brush holders can only accommodate brushes of a relatively short length. If longer brushes are placed within these brush holders, manual replacement becomes difficult if not impossible. Thus, there exists a need for a brush holder that can accommodate long-lasting brushes with increased carbon lengths while still allowing for manual replacement of the brushes when the brush holder is mounted in a constrained motor housing.

### SUMMARY OF THE INVENTION

One aspect of the present invention is to provide a brush holder assembly for a direct current motor, the brush holder assembly comprising a body; at least one brush receptacle positioned on the body, wherein the at least one brush receptacle is structured and arranged to slidably hold a brush and has an open proximal end for replacement of the brush and an open distal end for allowing the brush to contact a commutator; an arm pivotally connected to the body at a first pivot point; a pressure finger pivotally connected to the arm at a second pivot point, wherein the pressure finger pivots between an open position that allows for replacement of the brush and a closed position in which the pressure finger holds the brush against the commutator with an approximately constant force; and an extension spring connected to the pressure finger at a first connection point and to the body at a second connection point.

Another aspect of the present invention is to provide a brush holder assembly for a direct current motor comprising a housing for a motor, wherein the motor is selected from the group comprising motorized wheel motors for off-highway vehicles, locomotive motors, and oil rig motors; a body secured to the housing; at least one brush receptacle positioned on the body, wherein the at least one brush receptacle is structured and arranged to slidably hold a brush and has an open proximal end for replacement of the brush and an open distal end for allowing the brush to contact a commutator; an arm pivotally connected to the body at a first pivot point; a pressure finger pivotally connected to the arm at a second pivot point, wherein the pressure finger pivots between an open position that allows for replacement of the brush and a closed position in which the pressure finger holds the brush against the commutator with an approximately constant force; and an extension spring connected to the pressure finger at a first connection point and to the body at a second connection point.

A further aspect of the present invention is to provide a brush holder assembly for a direct current motor, the brush holder assembly comprising a body; at least one brush receptacle positioned on the body, wherein the at least one brush receptacle is structured and arranged to slidably hold a brush and has an open proximal end for replacement of the brush and an open distal end for allowing the brush to contact a commutator; an arm pivotally connected to the body at a first pivot point; a pressure finger pivotally connected to the arm at a second pivot point, wherein the pressure finger pivots between an open position that allows for replacement of the brush and a closed position in which the pressure finger holds the brush against the commutator with an approximately constant force; and a means for biasing the pressure finger towards the brush and away from the brush.

These and other aspects of the present invention will be more apparent from the following description.

### BRIEF DESCRIPTION OF THE DRAWINGS

FIG. 1 is a side view of a brush holder assembly in accordance with an embodiment of the present invention.

FIG. 2 is a plan view of a brush holder assembly in accordance with an embodiment of the present invention.

FIGS. 3a-3c are schematic representations depicting various operating positions of a brush holder assembly in accordance with an embodiment of the present invention.

FIG. 4 is a schematic representation of a brush holder assembly mounted to a motor housing that surrounds a commutator in accordance with an embodiment of the present invention.

FIG. 5 is a plan view of a brush holder assembly that may be attached to the motor housing of an off-highway vehicle with a motorized wheel, a locomotive, or an oil rig in accordance with an embodiment of the present invention.

FIG. 6 is a side view of a conventional brush holder assembly.

### DETAILED DESCRIPTION

The present invention provides a brush holder assembly for holding carbon brushes against the commutator of a DC motor. The brush holder assembly may include elongated brush receptacles that can accommodate longer carbon brushes, and a double fulcrum design that assists in holding the brushes against the commutator with a constant or nearly constant force. The double fulcrum design also assists in manually replacing the brushes within a confined motor housing. In a particular embodiment, the brush holder assembly may be mounted within the motor housing of an off-highway vehicle, a locomotive, or an oil rig. Off-highway vehicles may include construction and mining vehicles that are powered using motorized wheels, for example, trucks, cranes, continuous miners, drill rigs, crawler drills, and conveyors. For these kinds of applications, the space between the motor housing and the commutator may be particularly narrow and confined, and the double fulcrum design makes it possible to employ brushes with greater lengths of useful carbon, to hold the brushes with approximately constant force against the commutator, and to manually replace the brushes with minimal down time. In addition to off-highway vehicles, locomotives, and oil rigs, the brush holder assembly may be used for any other electrical machine or motor when a long-lasting carbon brush is desired.

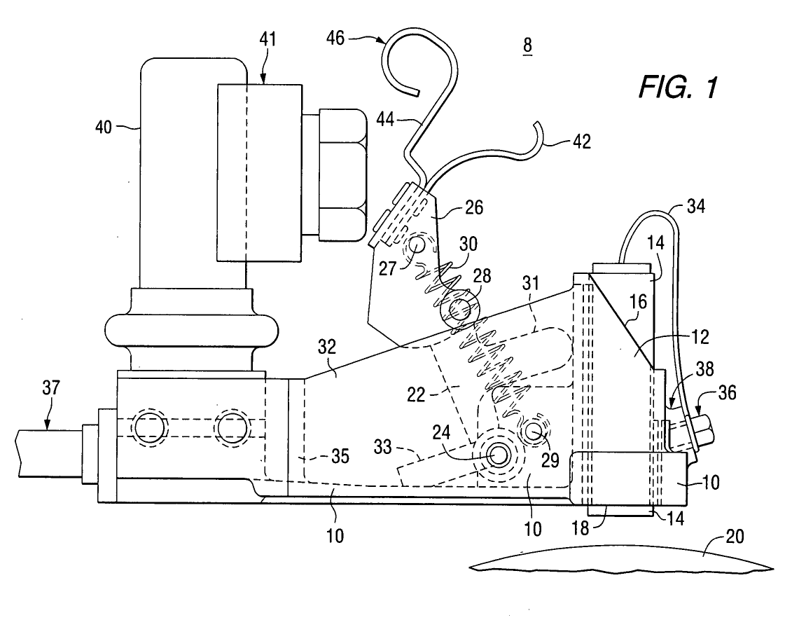

FIG. 1 is a side view of a brush holder assembly 8 in accordance with an embodiment of the present invention. As shown, a body 10 may contain one or more elongated brush receptacles 12, and each brush receptacle 12 may slidably hold a carbon brush 14. The brush receptacle 12 has an open proximal end 16 that allows for removal and replacement of the carbon brush 14 and an open distal end 18 that allows the carbon brush 14 to slide through and make contact with a commutator 20. For each brush receptacle 12, an arm 22 may be pivotally connected to the body 10 at a first pivot point 24, and a pressure finger 26 may be pivotally connected to the arm 22 at a second pivot point 28. The combination of the first pivot point 24 and the second pivot point 28 is referred to as a double fulcrum. An extension spring 30 may be connected between the pressure finger 26 and the body 10 to provide tension. One end of the extension spring 30 may be connected to the pressure finger 26 at a first connection point 27, and the other end of the extension spring 30 may be connected to the body 10 at a second connection point 29. The extension spring may be connected to the first connection point 27 and the second connection point 29 using any suitable means, such as by wrapping the ends of the spring around pins as shown in FIG. 1. The arm 22 may have a front extension 31 that guides and limits the rotational movement of the arm 22 and pressure finger 26 with respect to the brush receptacle 12. The arm 22 may also have a rear extension 33 that guides and limits the rotational movement of the arm 22 and pressure finger 26 with respect to a back wall 35 of the body 10. If the body 10 contains multiple brush receptacles 12, a side wall 32 may be provided as part of the body 10 to separate the individual arms 22, pressure fingers 26, extensions springs 30, and associated components.

Each brush 14 includes shunt wires 34 that are connected to a terminal lug 36 mounted on the body 10. A lead wire 37 may be provided to connect the brush holder assembly 8 to a source of electric current. The current flows through the shunt wires 34 and into the carbon brush 14, which passes the current to the commutator 20 when contact is made. The body 10 may include one terminal lug 36 for each brush 14. Alternatively, multiple brushes 14 may be connected to the same terminal lug 36. The terminal lugs 36 may be mounted anywhere on the body 10 that does not interfere with the operation of the pressure finger 26. Each terminal lug 36 may be mounted using a single mounting block 38, or multiple terminal lugs 36 may share the same mounting block 38. One or more insulating studs 40 may be connected to the body 10, and one or more mounting clamps 41 may be provided on the insulating stud 40 for securing the brush holder assembly 8 to a motor housing (not shown). The mounting clamp 41 may have any suitable size, design, or configuration.

The pressure finger 26 may include a contact tip 42 that is designed to make contact with the carbon brush 14 when the arm 22 and pressure finger 26 are positioned accordingly. The contact tip 42 may take the form of a curved metal piece as shown in FIG. 1, or it may have any other suitable shape or configuration. The pressure finger 26 may also include a lift extension 44 for moving the pressure finger 26 between an open position and a closed position. The lift extension 44 may include a lift loop 46 to assist in pivoting the pressure finger 26.

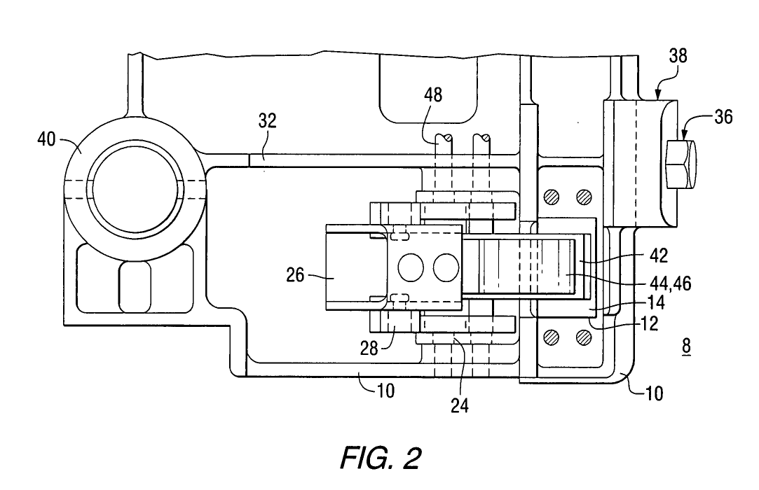

FIG. 2 is a plan view of the brush holder assembly 8 shown in FIG. 1. The body 10 contains one brush receptacle 12 and one carbon brush 14. The brush receptacle 12 is fitted with an arm 22 (not shown) that pivots around a first pivot point 24 and a pressure finger 26 that pivots around a second pivot point 28. The lift extension 44 and lift loop 46 can be manipulated to position the contact tip 42 on the carbon brush 14, or to remove the pressure finger 26 from the brush receptacle 12 which allows for brush replacement. For brush holder assemblies that contain more than one brush, the brush receptacle 12, brush 14, pressure finger 26, and accompanying components depicted in FIG. 2 are repeated side by side within a single body 10 and separated with a side wall 32. The pressure finger 26 and accompanying components may be connected between side walls 32 using a hinge pin 48, which may comprise a continuous rod. The hinge pin 48 may allow all pressure fingers 26 contained on the body 10 to operate independently or alternatively, to pivot in unison. One or more terminal lugs 36 may be mounted to a mounting block 38 in between each brush receptacle 12.

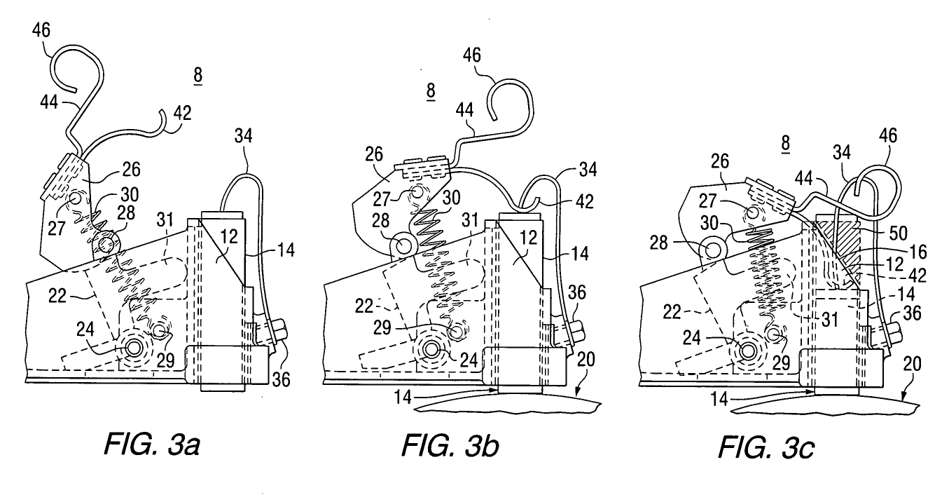

FIGS. 3a-3c depict various operating positions of the brush holder assembly 8. FIG. 3a depicts the pressure finger 26 in an open position that allows for installation or removal of the carbon brush 14 from the brush receptacle 12 when the shunt wires 34 are disconnected from the terminal lug 36. FIG. 3b depicts the pressure finger 26 in a closed position that allows the contact tip 42 to apply constant pressure, or approximately constant pressure, against the carbon brush 14. FIG. 3c depicts the pressure finger 26 in a closed position after the carbon brush 14 has worn away or reached the end of useful carbon life. The pressure finger 26 is pivoted between the open position and the closed position by manually moving the lift extension 44 via the lift loop 46.

To achieve the open position shown in FIG. 3a, the pressure finger 26 pivots away from the brush receptacle 12 in a counterclockwise direction around the second pivot point 28 and the arm 22 pivots away from the brush receptacle 12 around the first pivot point 24. As the pressure finger 26 pivots, the extension spring 30 passes through a point of maximum tension along its longitudinal axis. Beyond this point, the spring tension declines as the pressure finger 26 continues to pivot away from the brush receptacle 12. When the pressure finger 26 reaches the fully open position, it is essentially locked into place because additional pressure must be applied to the lift extension 44 to pivot the pressure finger 26 back towards the brush receptacle 12 and back through the point of maximum spring tension.

In the open position shown in FIG. 3a, the pressure finger 26, lift extension 44, and lift loop 46 should be able to pivot back as shown and avoid contacting the motor housing (not shown). At the same time, the pressure finger 26, lift extension 44, and lift loop 46 should be able to clear sufficient space around the brush receptacle 12 to allow for manual installation and replacement of a longer carbon brush 14. The double fulcrum design assists in achieving these goals by providing a mechanical advantage over a single fulcrum design. In a particular embodiment, the double fulcrum design may allow for the use of a 3-4 inch carbon brush with a useful carbon life of 2-3 inches in a motorized wheel that can typically only accept a 2 inch carbon brush with 1 inch of useful carbon life. However, the present invention is not limited to carbon brushes of any particular length.

To achieve the closed positions shown in FIGS. 3b and 3c, the pressure finger 26 pivots toward the brush receptacle 12 in a clockwise direction around the second pivot point 28 and the arm 22 pivots toward the brush receptacle 12 around the first pivot point 24. As the pressure finger 26 pivots, the extension spring 30 passes through the point of maximum tension along its longitudinal axis. Beyond this point, the spring tension declines as the pressure finger 26 continues to pivot toward the brush receptacle 12. When the pressure finger 26 reaches the fully closed position, it is essentially locked into place because additional pressure must be applied to the lift extension 44 to pivot the pressure finger 26 away from the brush receptacle 12 and back through the point of maximum spring tension. The front extension 31 of the arm 22 may contact the brush receptacle 12 to prevent the pressure finger 26 from rotating too far past the carbon brush 14.

In the closed positions shown in FIGS. 3b and 3c, the pressure finger 26 maintains constant force, or approximately constant force, against the brush 14. As a result, the brush 14 maintains constant or approximately constant force against the commutator 20. The first pivot point 24, second pivot point 28, first connection point 27, and second connection point 29 are positioned to facilitate the application of this constant or nearly constant force.

As shown in FIG. 3c, the proximal end 16 of the brush receptacle 12 may contain a cut-away 50 that facilitates the installation and removal of the carbon brush 14. Although it is depicted as having a diagonal shape in FIG. 3c, the cut-away may have any other suitable size, shape, or configuration.

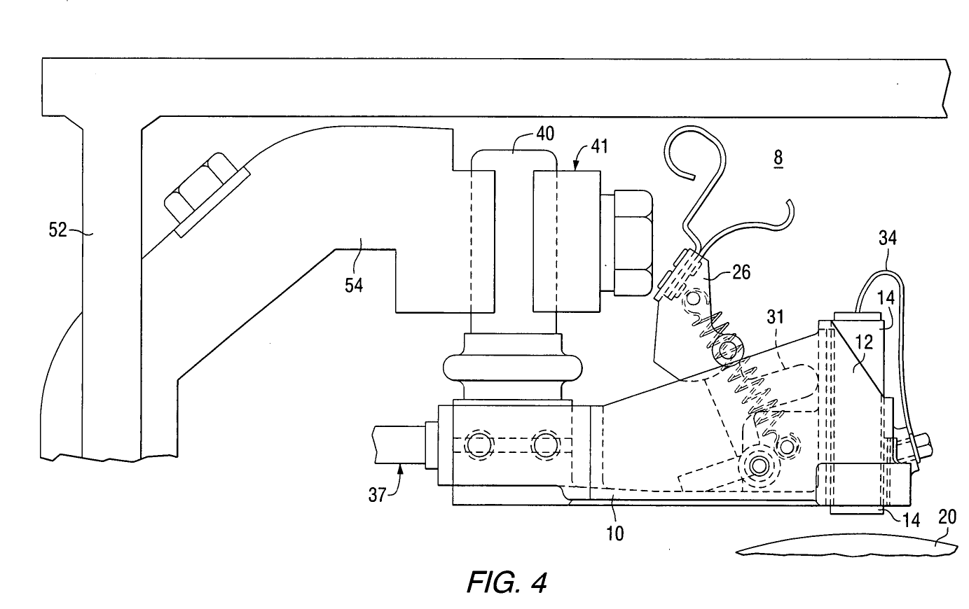

FIG. 4 is a schematic representation of a brush holder assembly 8 mounted to a motor housing 52 that surrounds a commutator 20, in accordance with an embodiment of the present invention. As shown, a mounting clamp 41 secures an insulating stud 40 of the brush holder assembly 8 to a mounting piece 54 on the motor housing 52. In addition to the representations depicted in FIG. 4, the mounting clamp 41, motor housing 52, and mounting piece 54 may have any other suitable size, shape, or configuration.

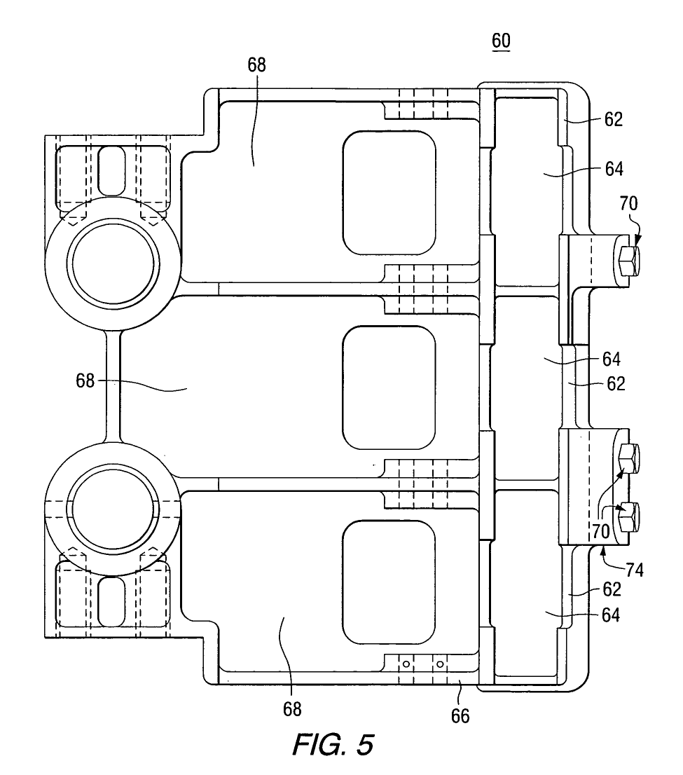

FIG. 5 is a plan view of a brush holder assembly 60 that may be attached to the motor housing of an off-highway vehicle with a motorized wheel, a locomotive, or an oil rig in accordance with an embodiment of the present invention. For these applications, the brush holder assembly 60 typically includes a body 66 with three brush receptacles 62 and three brushes 64. Each brush receptacle 62 is connected to a pressure finger 68 and associated components. For each brush 64, a terminal lug 70 may be mounted to the front of the body 66 in a position that does not impede the operation of the pressure finger 68 as it moves between an open position and a closed position. It is desirable to locate each terminal lug 70 approximately in between the brush receptacles 62 to ensure that the pressure finger 68 has sufficient clearance in the closed position to maintain contact with the brush 64. In a particular embodiment, which is shown in FIG. 4, two terminal lugs 70 may be mounted together on a single mounting block 74.

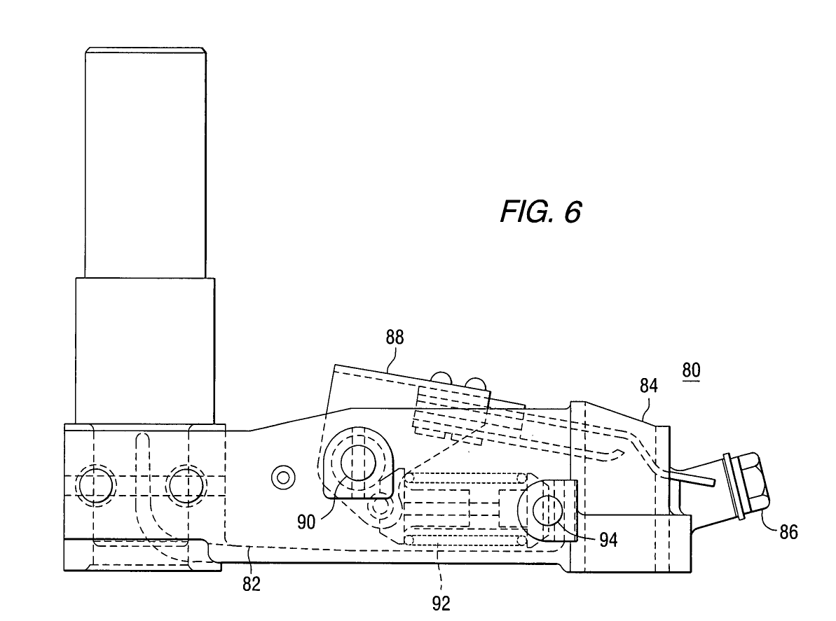

For comparison purposes, FIG. 6 is a plan view of a conventional brush holder assembly 80. As shown, the conventional brush holder assembly 80 comprises a body 82 containing one or more brush receptacles 84 and one or more terminal lugs 86 for connecting the shunt wires of a carbon brush. However, unlike the present invention, which includes a double fulcrum design, the conventional brush holder assembly 80 contains a pressure finger 88 with a linear lever design that only rotates about a single pivot point 90. Furthermore, unlike the present invention, which utilizes an extension spring, the conventional brush holder assembly 80 utilizes a compression spring 92. The compression spring 92 is connected to the brush receptacle 84 with a retaining rod 94 that does not allow for pivotal movement.

Because the conventional brush holder assembly 80 lacks a double fulcrum design, it cannot accommodate longer carbon brushes while being mounted within a constrained motor housing. When the conventional pressure finger 88 is pivoted to an open position, its length is restricted by the constraints of the motor housing. As a result, the pressure finger 88 cannot open far enough to provide sufficient clearance around the brush receptacle 84 to allow for manual installation or replacement of a longer carbon brush. The present invention, on the other hand, incorporates a double fulcrum design that improves upon the single pivot design of the conventional brush holder assembly 80. The double fulcrum design allows the pressure finger to fold back in a way that takes up less space and provides sufficient clearance around the brush receptacle 84 to allow for manual replacement of a longer carbon brush.

Whereas particular embodiments of the present invention have been described above for purposes of illustration, it will be evident to those skilled in the art that numerous variations of the details of the described embodiments may be made without departing from the invention as defined in the appended claims.

1. A brush holder assembly for a direct current motor, the brush holder assembly comprising:
a body;
at least one brush receptacle positioned on the body, wherein the at least one brush receptacle is structured and arranged to slidably hold a brush and has an open proximal end for replacement of the brush and an open distal end for allowing the brush to contact a commutator;
an arm pivotally connected to the body at a first pivot point;
a pressure finger pivotally connected to the arm at a second pivot point, wherein the pressure finger pivots between an open position that allows for replacement of the brush and a closed position in which the pressure finger holds the brush against the commutator with an approximately constant force; and
an extension spring connected to the pressure finger at a first connection point and to the body at a second connection point.

2. The brush holder assembly of claim 1, wherein the first pivot point, the second pivot point, the first connection point, and the second connection point are positioned to allow the pressure finger to hold the brush against the commutator with an approximately constant force.

3. The brush holder assembly of claim 1, further comprising a front extension on the arm to guide movement of the pressure finger with respect to the brush receptacle.

4. The brush holder assembly of claim 1, further comprising a rear extension on the arm to guide movement of the pressure finger and arm with respect to a rear wall of the body.

5. The brush holder assembly of claim 1, wherein the proximal end of the brush receptacle has a cut-away that allows at least a portion of the pressure finger to slidably move within the brush receptacle.

6. The brush holder assembly of claim 5, wherein the cut-away is diagonal.

7. The brush holder assembly of claim 1, further comprising at least one terminal lug mounted to the body for connecting the brush to a source of electric current.

8. The brush holder assembly of claim 7, wherein the at least one terminal lug is mounted to the body using a mounting block.

9. The brush holder assembly of claim 8, wherein a plurality of terminal lugs shares the same mounting block.

10. The brush holder assembly of claim 1, further comprising a lift extension connected to the pressure finger and a lift loop connected to the lift extension for moving the pressure finger between the open position and the closed position.

11. The brush holder assembly of claim 1, further comprising a mounting assembly for securing the brush holder assembly to a motor housing in a position that allows for manual replacement of the brush without removing the brush holder assembly.

12. A brush holder assembly for a direct current motor comprising:
a housing for a motor, wherein the motor is selected from the group comprising motorized wheel motors for off-highway vehicles, locomotive motors, and oil rig motors;
a body secured to the housing;
at least one brush receptacle positioned on the body, wherein the at least one brush receptacle is structured and arranged to slidably hold a brush and has an open proximal end for replacement of the brush and an open distal end for allowing the brush to contact a commutator;
an arm pivotally connected to the body at a first pivot point;
a pressure finger pivotally connected to the arm at a second pivot point, wherein the pressure finger pivots between an open position that allows for replacement of the brush and a closed position in which the pressure finger holds the brush against the commutator with an approximately constant force; and
an extension spring connected to the pressure finger at a first connection point and to the body at a second connection point.

13. The brush holder assembly of claim 12, wherein the first pivot point, the second pivot, the first connection point, and the second connection point are positioned to allow the pressure finger to hold the brush against the commutator with an approximately constant force.

14. The brush holder assembly of claim 12, further comprising a front extension on the arm to guide movement of the pressure finger with respect to the brush receptacle.

15. The brush holder assembly of claim 12, further comprising a rear extension on the arm to guide movement of the pressure finger and arm with respect to a rear wall of the body.

16. The brush holder assembly of claim 12, wherein the body is mounted in a position that allows for manual replacement of the brush without removing the body from the housing.

17. The brush holder assembly of claim 12, wherein the proximal end of the brush receptacle has a cut-away that allows at least a portion of the pressure finger to slidably move within the brush receptacle.

18. The brush holder assembly of claim 17, wherein the cut-away is diagonal.

19. The brush holder assembly of claim 12, further comprising at least one terminal lug mounted to the body for connecting the brush to a source of electric current.

20. The brush holder assembly of claim 19, wherein the at least one terminal lug is mounted to the body using a mounting block.

21. The brush holder assembly of claim 20, wherein a plurality of terminal lugs share the same mounting block.

22. The brush holder assembly of claim 12, further comprising a lift extension connected to the pressure finger and a lift loop connected to the lift extension for moving the pressure finger between the open position and the closed position.

23. A brush holder assembly for a direct current motor, the brush holder assembly comprising:
a body;
at least one brush receptacle positioned on the body, wherein the at least one brush receptacle is structured and arranged to slidably hold a brush and has an open proximal end for replacement of the brush and an open distal end for allowing the brush to contact a commutator;
an arm pivotally connected to the body at a first pivot point;
a pressure finger pivotally connected to the arm at a second pivot point, wherein the pressure finger pivots between an open position that allows for replacement of the brush and a closed position in which the pressure finger holds the brush against the commutator with an approximately constant force; and
a means for biasing the pressure finger towards the brush and away from the brush.
